(19) United States
(12) Patent Application Publication
(10) Pub. No.: US 2018/0145299 A1
(43) Pub. Date: May 24, 2018

(54) POROUS FILM, SEPARATOR INCLUDING THE SAME, ELECTROCHEMICAL DEVICE INCLUDING THE POROUS FILM, AND METHOD OF PREPARING THE POROUS FILM

(71) Applicant: Samsung Electronics Co., Ltd., Suwon-si (KR)

(72) Inventors: Ryo Iwamuro, Kanagawa (JP); Hironari Takase, Kanagawa (JP); Yoshitaka Yamaguchi, Kanagawa (JP); Mitsuharu Kimura, Kanagawa (JP)

(21) Appl. No.: 15/816,974

(22) Filed: Nov. 17, 2017

(30) Foreign Application Priority Data
Nov. 18, 2016 (JP) 2016-224942
Oct. 18, 2017 (JP) 2017-202121
Nov. 7, 2017 (KR) 10-2017-0147625

(51) Int. Cl. H01M 2/16; H01M 10/0525; H01M 2/14; H01G 11/52; H01G 11/84

(52) U.S. Cl. CPC H01M 2/1626; H01M 10/0525; H01G 11/84; H01G 11/52; H01M 2/145

(57) ABSTRACT

Provided are a porous film, a separator including the porous film, an electrochemical device including the porous film, and a method of preparing the porous film. The porous film includes an aqueous resin of a single film having an elongation at break of about 50% or greater; and cellulose nanofibers, wherein an elongation at break of the porous film is about 3% or greater.

### CROSS-REFERENCE TO RELATED APPLICATIONS

This application claims the benefit of Japanese Patent Application No. 2016-224942, filed on Nov. 18, 2016, in the Japanese Patent Office; Japanese Patent Application 2017-202121, filed on Oct. 18, 2017, in the Japanese Patent Office; and Korean Patent Application No. 10-2017-0147625, filed on Nov. 7, 2017, in the Korean Intellectual Property Office, the entire disclosures of which are hereby incorporated by reference.

### BACKGROUND

### 1. Field

The present disclosure relates to a porous film, a separator including the porous film, an electrochemical device including the porous film, and a method of preparing the porous film.

### 2. Description of the Related Art

Secondary batteries are widely used in mobile electronic devices, electric vehicles, and hybrid vehicles. Particularly, development of a lithium ion secondary battery has been actively done due to its high energy density. Currently, a polyolefin-based porous film which is inexpensive, chemically stable, and excellent in mechanical properties is mainly used as a separator for a lithium ion secondary battery. However, heat resistance of the polyolefin-based porous film has a problem, and thus a method of applying ceramic particles or chemical cross-linking agent has been studied in order to increase the heat resistance. Still, a manufacture cost increases when this method is used since the process of applying the coating material on the porous film increases. Therefore, it has been studied to use a material having high heat resistance, and in particular, cellulose has attracted attention because it is thermally stable up to about 300° C. and is a wood-derived material that can be reproduced.

Separators using cellulose fibers tend to be hard and fragile separators because a number of hydrogen bonds between the fibers may be formed due to hydroxyl groups present on surfaces of the cellulose fibers. In this regard, handleability and the handling property of a separator using cellulose fibers may deteriorate, particularly in the dry atmosphere. Accordingly, a separator for reducing an amount of hydrogen bonds between cellulose fibers and improving mechanical strength by mixing cellulose fibers and synthetic fibers, such as polyester fibers, has been disclosed (e.g., Patent Document 1: Japanese Patent Publication No. 2015-176888). Further, in order to improve the strength between cellulose fibers, a separator, in which a cellulose surface is cross-linked using a carboxyimide group-containing compound or an oxazoline group-containing compound having a terminal isocyanate group as a cross-linking agent, has been disclosed (e.g., Patent Document 2: Japanese Patent Publication No. 2014-198835). Similarly, a separator having improved strength by cross-linking cellulose fibers using a reactive cross-linking agent produced by an addition reaction of a polyfunctional isocyanate compound and an active hydrogen-containing compound has been disclosed (e.g., Patent Document 3: Japanese Patent Publication No. 2016-072309).

Still, there remains a need for new porous films useful as separators as well as methods for preparing and using same.

### SUMMARY

Provided is a porous film having an excellent mechanical strength by suppressing formation of a hydrogen bond of cellulose fibers.

Provided is a separator including the porous film.

Provided is an electrochemical device including the separator.

Provided is a method of preparing the porous film.

Additional aspects will be set forth in part in the description which follows and, in part, will be apparent from the description, or may be learned by practice of the presented embodiments.

According to an aspect of an embodiment, a porous film includes an aqueous resin having an elongation at break of about 50% or greater measured in a film of the aqueous resin; and cellulose nanofibers, wherein an elongation at break of the porous film is about 3% or greater.

According to an aspect of another embodiment, a separator includes the porous film.

According to an aspect of another embodiment, an electrochemical device includes the separator.

According to an aspect of another embodiment, a method of preparing a porous film having an elongation at break of about 3% or greater includes mixing a solution including cellulose nanofibers with an aqueous resin having an elongation at break of about 50% or greater measured in a film of the aqueous resin to prepare a resin mixture solution; and mixing a water-soluble pore-forming agent to the resin mixture solution to prepare a porous film.

### BRIEF DESCRIPTION OF THE DRAWINGS

These and/or other aspects will become apparent and more readily appreciated from the following description of the embodiments, taken in conjunction with the accompanying drawings in which:

FIG. 1 is an absorption spectrum that shows the results of infrared total reflection absorption measurement of porous films prepared in Examples 1 to 3 and Comparative Examples 1 and 2; and

FIG. 2 is a schematic view of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, as the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope are encompassed in the present inventive concept.

The terms used herein are merely used to describe particular embodiments, and are not intended to limit the present inventive concept. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added.

In the drawings, the thicknesses of layers and regions are exaggerated or reduced for clarity. Like reference numerals in the drawings denote like elements, and thus their description will be omitted. Throughout the specification, it will be understood that when a component, such as a layer, a film, a region, or a plate, is referred to as being “on” another component, the component can be directly on the other component or intervening components may be present thereon. Throughout the specification, While such terms as “first,” “second,” etc., may be used to describe various components, such components must not be limited to the above terms. The above terms are used only to distinguish one component from another.

Hereinafter, according to one or more embodiments, a porous film, a separator including the porous film, an electrochemical device including the porous film, and a method of preparing the porous film will be described.

According to an embodiment, a porous film includes an aqueous resin, wherein the aqueous resin when cast as a film with specimen dimension under ASTM D638 has an elongation at break of about 50% or greater; and cellulose nanofibers, and an elongation at break of the porous film is about 3% or greater.

When the porous film includes the resin, wherein a single film of the resin has an elongation at break of about 50% or greater, at least a part of surfaces of the cellulose nanofibers are coated with the resin. The resin on the surfaces of the cellulose nanofibers may modify contact points where hydrogen bonds are formed on the surfaces of the cellulose nanofibers and thus may suppress formation of hydrogen bonds between the nanofibers due to hydroxyl groups present on the surfaces of the cellulose nanofibers. Thus, firm bonding formed by numerous hydrogen bonds present on the surfaces of the cellulose nanofibers may be suppressed, which may result in improvement of mechanical strength, or, for example, an elongation at break, of a separator including the porous film. That is, when at least a part of the hydroxyl groups present on the surfaces of the cellulose nanofibers are coated with the resin, formation of hydrogen bonds between the cellulose nanofibers by the hydroxyl groups may be suppressed, and thus, as a permeability of the porous film may be maintained, mechanical strength of the porous film may improve. The resin included in the porous film may be an aqueous resin.

An elongation at break of the porous film may be about 3% or greater, about 3.5% or greater, about 4% or greater, about 4.5% or greater, about 5% or greater, about 5.5% or greater, about 6% or greater, about 6.5% or greater, or about 7% or greater. When the porous film has an elongation at break of about 3% or greater, the porous film may be less hard and may not be fragile.

Non-woven fabric according to an embodiment may be used in, for example, filters of air conditioners or vacuum cleaners, gas adsorption filters, soundproofing materials, dustproofing materials, reinforcing materials, or non-aqueous electrochemical separators, but may be suitable as a separator for a lithium ion secondary battery. For example, the non-woven fabric may be suitable as a separator for a lithium ion secondary battery including microcellulose fibers (cellulose nanofibers) and an aqueous resin.

Hereinafter, description may include the non-woven fabric according to an embodiment as an example of a separator for a lithium ion secondary battery.

(Microcellulose Fibers)

In an embodiment, microcellulose fibers may be used as a material that forms a separator, and cellulose having an I-type crystal structure may be used as the microcellulose fibers in terms of preventing strength deterioration or dissolution of the cellulose fibers. For example, a method for measuring I-type crystal may be as disclosed in U.S. Pat. No. 8,436,165.

The cellulose nanofibers may include at least one selected from plant cellulose, animal cellulose, and microbial cellulose.

Examples of cellulose that is to be a raw material of the microcellulose fibers may include, but not particularly limited to, natural cellulose that is separated from biosynthesis of plants, animals, or bacteria-produced gels and then purified. In particular, for example, the cellulose may be softwood pulp, hardwood pulp, cottonwood pulp such as cotton linter, non-wood pulp such as straw pulp or bagasse pulp, bacteria cellulose or cellulose isolated from Ascidiacea, or cellulose isolated from seaweed.

An average fiber diameter of the microcellulose fibers may be about 3 nm to about 300 nm, about 5 nm to about 200 nm, about 10 nm to about 100 nm, about 20 nm to about 150 nm, about 30 nm to about 100 nm, or about 40 nm to about 80 nm. When the average fiber diameter is less than 3 nm, the cellulose may not maintain the fibrous shape in an I-type crystal structure. In some embodiments, the microcellulose fibers do not include fibers having an average fiber diameter of about 1 um or greater in any significant amount. In particular, the amount of fibers having an average fiber diameter of less than 1 um may be about 80 weight % or more, about 85 weight % or more, about 90 weight % or more, or about 95 weight % or more based on the total amount of fibers used. Also, an amount of fibers having an average fiber diameter of 500 nm or less may be about 80 weight % or more, about 85 weight % or more, about 90 weight % or more, or about 95 weight % or more based on the total amount of fibers used. When the amount of fibers having a large fiber diameter is lowered, the thickness, the fine hole diameter, and the Gurley permeability of the separator may be easily controlled during preparation of a film as the separator.

Fiber diameter may be measured by observing a film with a transmission electron microscope or a scanning electron microscope, where the film is in a separator state (e.g., a film in a separator state is a film that can be used as separator as it is) or formed by casting and drying a dilute solution of the cellulose fibers. By comprehensively evaluating a viscosity (an E type or B type viscometer) of the cellulose fiber water dispersion of about 0.1 weight % to less than about 2 weight %, tensile strength, and specific surface area of the porous film, a ratio of the fibers having a fiber diameter of less than 1 um may be obtained. For example, this may be referred to International Patent WO 2013/054884.

(Aqueous Resin)

In an embodiment, as a material forming a separator, an aqueous resin having an elongation at break, measured in a film of the aqueous resin, of about 50% or greater, about 100% or greater, about 150% or greater, about 200% or greater, about 250% or greater, about 300% or greater, about 350% or greater, about 400% or greater, about 450% or greater, about 500% or greater, about 550% or greater, about 600% or greater, about 650% or greater, or about 700% or greater may be used together with microcellulose fibers.

When the aqueous resin is used, surfaces of the cellulose fibers may be coated with the aqueous resin, which allows contact points where hydrogen bonds on the surfaces of the cellulose fibers to be modified. Therefore, firm bonding formed by numerous hydrogen bonds present on the surfaces of the microcellulose fibers may be suppressed, and thus mechanical strength (an elongation at break) of the separator may improve. When an elongation at break of the a film of the aqueous resin, i.e., a single film of the aqueous resin, is less than about 50%, flexibility of non-woven fabric prepared by using the film together with the microcellulose fibers may be insufficient.

Also, unlike a conventional separator, since the separator prepared by using the aqueous resin does not include synthetic fibers (such as polyester fibers) having a large fiber diameter compared to that of the cellulose fibers, migration of lithium ions between electrodes may not be interfered when the separator is used in a lithium ion secondary battery. As a result, the lithium ion secondary battery may have preferable battery performance (cycle characteristics).

As used herein, the term “single film” refers to a film that is prepared by casting an aqueous resin on a container such as Schale and drying a solvent.

Also, as used herein, the term “aqueous resin” refers to a resin that can be dissolved and/or dispersed in water as a solvent. The term “dispersed in water” refer to “stay in a stable state in water without phase separation or precipitation. For example, a resin that can be dipersed in water forms a stable emulsion or latex of resin. Meanwhile, a resin that cannot be dispersed in water, i.e., non-aqueous resin, cannot form a stable emulsion of the resin but causes a phase separation or precipitation.

Also, as used herein, the term “elongation at break” is a value that is measured based on JIS K7127.

Examples of the aqueous resin may include a urethane resin, an acrylic resin, a phenol resin, a polyester resin, an epoxy resin, a polystyrene resin, a polyvinyl alcohol, maleic acid modified polyethylene, and a polyacrylamide resin, but the aqueous resin may be at least one selected from a urethane resin, a polyvinyl alcohol, and maleic acid modified polyethylene, in terms of its single film having an excellent elongation at break.

Further, the urethane resin may be either a reactive type or a non-reactive type or may include both a reactive type and a non-reactive type.

Also, in terms of internal voltage characteristics or flexibility and complication with microcelullose fibers of the resin while using a lithium ion secondary battery, the urethane resin includes at least one backbone selected from a polyester backbone, a polyether backbone, and a polycarbonate backbone. In particular, for example, the urethane resin may be a commercially available product such as Superflex series (available from Dai-ichi Kogyo Seiyaku Co., LTD), Elastron series (available from Dai-ichi Kogyo Seiyaku Co., LTD), Hydran series (available from DIC Co., LTD), Burnock series (available from DIC Co., LTD), EVNol series (available from Nitka Chemicals Co., LTD), Pascol series (available from Myojo industrial chemicals Co., LTD), and Adeka Bontighter series (available from Adeca Co., LTD).

(Separator for Lithium Ion Secondary Battery)

According to another embodiment, a separator includes the porous film.

For example, the porous film itself may be used as a separator. When the porous film is used as a separator, the porous film may allow migration of ions between electrodes in an electrochemical device including the porous film as a separator and may block electrical contact between the electrodes, and thus performance of the electrochemical device may improve.

The separator for a lithium ion secondary battery according to an embodiment may have an elongation at break of about 3% or greater in terms of improving handleability (recycleability) during preparation of a secondary battery.

Also, as described above, when the separator for a lithium ion secondary battery according to an embodiment may include an aqueous resin of a single film having an elongation at break of about 50% or greater, handleability (recycleability) during preparation of a secondary battery may improve due to having an elongation at break of about 3% or greater while improving mechanical strength (an elongation at break) of the separator. As a result, breakage of the separator during preparation of a secondary battery may be prevented.

Also, in the separator for a lithium ion secondary battery according to an embodiment, an amount of the aqueous resin based on the total amount of the microcellulose fibers may be in a range of about 0.1 weight % to about 50 weight %, about 0.5 weight % to about 40 weight %, about 1 weight % to about 30 weight %, about 2 weight % to about 20 weight %, or about 5 weight % to about 15 weight %. When an amount of the aqueous resin is greater than 50 weight %, holes of the separator may be blocked, and thus ion conductivity of the separator may be deteriorated. When an amount of the aqueous resin is less than about 0.1 weight %, an elongation at break of the separator may not improve, and the separator may be fragile. For example, an amount of the aqueous resin based on 100 parts by weight of the microcellulose fibers may be in a range of about 1 part to about 50 parts by weight, about 0.5 parts to about 40 parts by weight, about 1 part to about 30 parts by weight, about 2 parts to about 20 parts by weight, or about 5 parts to about 15 parts by weight.

Also, a thickness of the separator for a lithium ion secondary battery according to an embodiment may be in a range of about 5 um to about 30 um, about 7 um to about 25 um, or about 10 um to about 20 um. When a thickness of the separator is less than about 5 um, a tensile strength of the separator may be weakened, and thus the separator may not be wound up during recycling. When a thickness of the separator is greater than 30 um, a volume occupied by the separator in the batter may increase, and thus a battery capacity may decrease.

Further, a permeability of the separator for a lithium ion secondary battery according to an embodiment may be in a range of about 10 sec/100 cc to about 1000 sec/100 cc, about 20 sec/100 cc to about 950 sec/100 cc, about 50 sec/100 cc to about 900 sec/100 cc, about 80 sec/100 cc to about 850 sec/100 cc, about 100 sec/100 cc to about 800 sec/100 cc, about 150 sec/100 cc to about 850 sec/100 cc, about 200 sec/100 cc to about 800 sec/100 cc, about 250 sec/100 cc to about 700 sec/100 cc, or about 300 sec/100 cc to about 600 sec/100 cc. When a permeability of the separator is less than about 10 sec/100 cc, inert lithium may be easily generated as a pore distribution of the separator increases. When a permeability of the separator is greater than about 1000 sec/100 cc, ion conductivity of the separator may deteriorate.

Also, as used herein, the term “Gurley permeability” is a value measured based on JIS P8117.

Further, in terms of strength required of the separator, a tensile strength at break of the separator may be about 200 kgf/cm² or greater, about 250 kgf/cm² or greater, about 300 kgf/cm² or greater, about 350 kgf/cm² or greater, about 360 kgf/cm² or greater, about 380 kgf/cm² or greater, about 400 kgf/cm² or greater, about 420 kgf/cm² or greater, about 440 kgf/cm² or greater, about 460 kgf/cm² or greater, or about 480 kgf/cm² or greater.

Also, as used herein, the term “tensile strength at break” may be measured based on JIS K7127 in the same manner used to measure the elongation at break as described above.

According to another embodiment, an electrochemical device includes the separator. When the electrochemical device includes the separator described above, lifespan characteristics of the electrochemical device may improve.

The electrochemical device is not particularly limited, and any material capable of saving and/or emitting electricity by an electrochemical reaction in the art may be used. The electrochemical device may be an electrochemical cell or an electric double layer capacitor. The electrochemical device may be a lithium battery, an alkali metal battery such as a sodium battery, or a fuel battery. The electrochemical cell may be a primary battery or a rechargeable secondary battery. For example, the electrochemical cell may be a lithium ion battery, a lithium polymer battery, a lithium sulfur battery, or a lithium air battery.

For example, the electrochemical cell may include a cathode; an anode; and a separator disposed between the cathode and the anode.

The lithium battery may be manufactured in the following manner.

First, an anode is prepared.

For example, an anode active material, a conducting agent, a binder, and a solvent are mixed to prepare an anode active material composition. In some embodiments, the anode active material composition may be directly coated on a metallic current collector and dried to prepare an anode plate. In some embodiments, the anode active material composition may be cast on a separate support to form an anode active material film, which may then be separated from the support and laminated on a metallic current collector to prepare an anode plate.

In some embodiments, the anode active material may be any anode active material for a lithium battery available in the art. For example, the anode active material may include at least one selected from lithium metal, a metal alloyable with lithium, a transition metal oxide, a non-transition metal oxide, and a carbonaceous material.

Examples of the metal alloyable with lithium are Si, Sn, Al, Ge, Pb, Bi, Sb, a Si—Y alloy (where Y is an alkali metal, an alkali earth metal, a Group XIII element, a Group XIV element, a transition metal, a rare earth element, or a combination thereof, and Y is not Si), and a Sn—Y alloy (where Y is an alkali metal, an alkali earth metal, a Group XIII element, a Group XIV element, a transition metal, a rare earth element, or a combination thereof, and Y is not Sn). In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

Examples of the transition metal oxide include a lithium titanium oxide, a vanadium oxide, and a lithium vanadium oxide.

Examples of the non-transition metal oxide include SnO₂ and SiOₓ (where 0<x<2).

Examples of the carbonaceous material are crystalline carbon, amorphous carbon, and mixtures thereof. An example of the crystalline carbon is graphite, such as natural graphite or artificial graphite, in shapeless, plate, flake, spherical, or fibrous form. Examples of the amorphous carbon are soft carbon (carbon sintered at low temperatures), hard carbon, meso-phase pitch carbides, and sintered cokes.

Examples of the conducting agent may include natural graphite, artificial graphite, carbon black, acetylene black, or Ketjen black; carbon fibers; or a metal powder or metal fibers of copper, nickel, aluminum, or silver. Also, a conducting material such as a polyphenylene derivative or a mixture including a conducting material may be used, but examples of the conducting material are not limited thereto, and any material available as a conducting material in the art may be used. Also, a crystalline material may be added as a conducting material.

Examples of the binder may include a vinylidene fluoride/hexafluoropropylene copolymer, polyvinylidene fluoride (PVDF), polyacrylonitrile, polymethyl methacrylate, polytetrafluoroethylene, and mixtures thereof, and a styrene-butadiene rubber polymer may be further used as a binder in addition to the cross-linked polymer, but embodiments are not limited thereto, and any material available as a binder in the art may be additionally used.

Examples of the solvent may include N-methylpyrrolidone, acetone, and water, but embodiments are not limited thereto, and any material available as a solvent in the art may be used.

The amounts of the anode active material, the conducting agent, the binder, and the solvent may be in ranges commonly used in lithium batteries. At least one of the conducting agent, the binder, and the solvent may be omitted according to a use and a structure of the lithium battery.

Next, a cathode may be prepared according to a cathode preparation method.

The cathode may be prepared in the same manner as the anode, except that a cathode active material is used instead of an anode active material. Also, the same conducting agent, binder, and solvent used in the preparation of the anode may be used in the preparation of a cathode active material composition.

For example, a cathode active material, a conducting agent, a binder, and a solvent may be mixed together to prepare a cathode active material composition. The cathode active material composition may be directly coated on an aluminum current collector to prepare a cathode plate. In some embodiments, the cathode active material composition may be cast on a separate support to form a cathode active material film, which may then be separated from the support and laminated on an aluminum current collector to prepare a cathode plate. The cathode is not limited to the examples described above, and may be one of a variety of types.

The cathode active material may include at least one selected from a lithium cobalt oxide, a lithium nickel cobalt manganese oxide, a lithium nickel cobalt aluminum oxide, a lithium iron phosphate, and a lithium manganese oxide, but embodiments are not limited thereto, and any material available as a cathode active material in the art may be used.

For example, the cathode active material may be a compound represented by one of the following formulae: LiₐA_{1-b}B_{b}D₂ (where 0.90≤a≤1.8 and 0≤b≤0.5); LiₐE_{1-b}B_{b}O_{2-c}D_{c} (where 0.90≤a≤1.8, 0≤b≤0.5, and 0≤c≤0.05); LiE_{2-b}B_{b}O_{4-c}D_{c} (where 0≤b≤0.5 and 0≤c≤0.05); LiₐNi_{1-b-c}CO_{b}B_{c}Dₐ (where 0.90≤a≤1.8, 0≤b≤0.5, 0≤c≤0.05, and 0<α≤2); LiₐNi_{1-b-c}Co_{b}B_{c}O₂₋ₐF_{α} (where 0.90≤a≤1.8, 0≤b≤0.5, 0≤c≤0.05, and 0<α<2); LiₐNi_{1-b-c}CO_{b}B_{c}O₂₋ₐF₂ (where 0.90≤a≤1.8, 0≤b≤0.5, 0≤c≤0.05, and 0<α≤2); LiₐNi_{1-b-c}Mn_{b}B_{c}Dₐ (where 0.90≤a≤1.8, 0≤b≤0.5, 0≤c≤0.05, and 0<α≤2); LiₐNi_{1-b-c}Mn_{b}B_{c}O₂₋ₐFₐ (where 0.90≤a≤1.8, 0≤b≤0.5, 0≤c≤0.05, and 0<α≤2); LiₐNi_{1-b-c}Mn_{b}B_{c}O₂₋ₐF₂ (where 0.90≤a≤1.8, 0≤b≤≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}G_{b}O₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂GbO₄ (where 0.90≤a≤1.8 and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above, A may be selected from nickel (Ni), cobalt (Co), manganese (Mn), and combinations thereof; B may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from oxygen (O), fluorine (F), sulfur (S), phosphorus (P), and combinations thereof; E may be selected from cobalt (Co), manganese (Mn), and combinations thereof; F may be selected from fluorine (F), sulfur (S), phosphorus (P), and combinations thereof; G may be selected from aluminum (Al), chromium (Cr), manganese (Mn), iron (Fe), magnesium (Mg), lanthanum (La), cerium (Ce), strontium (Sr), vanadium (V), and combinations thereof; Q is selected from titanium (Ti), molybdenum (Mo), manganese (Mn), and combinations thereof; I is selected from chromium (Cr), vanadium (V), iron (Fe), scandium (Sc), yttrium (Y), and combinations thereof; and J may be selected from vanadium (V), chromium (Cr), manganese (Mn), cobalt (Co), nickel (Ni), copper (Cu), and combinations thereof.

The compounds listed above as cathode active materials may have a surface coating layer (hereinafter, also referred to as “coating layer”). Alternatively, a mixture of a compound without a coating layer and a compound having a coating layer, the compounds being selected from the compounds listed above, may be used. In some embodiments, the coating layer may include at least one compound of a coating element selected from the group consisting of an oxide, a hydroxide, an oxyhydroxide, an oxycarbonate, and a hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In some embodiments, the coating layer may be formed using any method that does not adversely affect the physical properties of the cathode active material when a compound of the coating element is used. For example, the coating layer may be formed using a spray coating method or a dipping method. The coating methods may be well understood by one of ordinary skill in the art, and thus a detailed description thereof will be omitted.

In some embodiments, the cathode active material may be LiCoO₂, LiMnₓO₂ₓ (where x=1 or 2), LiNi₁₋ₓMnₓO₂ₓ (where 0<x<1), LiNi_{1-x-y}COₓMn_{y}O₂ (where 0≤x≤0.5 and 0≤y≤0.5), or LiFePO₄.

Then, the separator is disposed between the cathode and the anode.

Subsequently, an electrolyte is prepared.

In some embodiments, the electrolyte may be an organic electrolyte solution. In some embodiments, the electrolyte may be in a solid phase. Examples of the electrolyte are boron oxide and lithium oxynitride. Any material available as a solid electrolyte in the art may be used. In some embodiments, the solid electrolyte may be formed on the anode by, for example, sputtering.

In some embodiments, the organic electrolyte solution may be prepared by dissolving a lithium salt in an organic solvent.

The organic solvent may be any solvent available as an organic solvent in the art.

In some embodiments, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, or a mixture thereof.

In some embodiments, the lithium salt may be any material available as a lithium salt in the art. In some embodiments, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently a natural number), LiCl, LiI, or a mixture thereof.

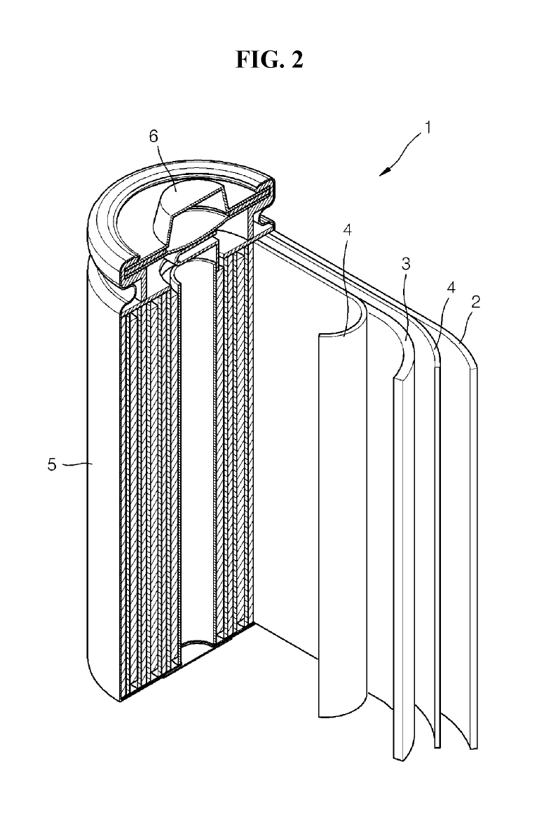

Referring to FIG. 2, a lithium battery 1 includes a cathode 3, an anode 2, and a separator 4. In some embodiments, the cathode 3, the anode 2, and the separator 4 may be wound or folded, and then sealed in a battery case 5. In some embodiments, the battery case 5 may be filled with an organic electrolytic solution and sealed with a cap assembly 6, thereby completing the manufacture of the lithium battery 1. In some embodiments, the battery case 5 may be a cylindrical type, a rectangular type, or a thin-film type. For example, the lithium battery 1 may be a thin-film type battery. In some embodiments, the lithium battery 1 may be a lithium ion battery.

In some embodiments, the separator may be disposed between the cathode and the anode to form a battery assembly. In some embodiments, the battery assembly may be stacked in a bi-cell structure and impregnated with the organic electrolytic solution. In some embodiments, the resultant assembly may be inserted into a pouch and hermetically sealed, thereby completing the manufacture of a lithium ion polymer battery.

In some embodiments, a plurality of battery assemblies may be stacked to form a battery pack, which may be used in any device that requires high capacity and high output, for example, in a laptop computer, a smartphone, or an electric vehicle.

The lithium battery may have improved lifetime characteristics and high-rate characteristics, and thus may be used in an electric vehicle (EV), for example, in a hybrid vehicle such as a plug-in hybrid electric vehicle (PHEV).

Next, a method of preparing a separator according to another embodiment will be described.

According to another embodiment, the method of preparing a separator includes preparing an aqueous resin mixture solution, prepating a coating solution, applying the coating solution on a substrate, drying the coating solution applied on the substrate, and separating a film from the substrate after the drying. Also, according to the need, a pressing process may be performed on the separator. Again, the pressing process is not essential.

<Aqueous Resin Mixture Solution Preparation Process>

First, a suspension aqueous solution of microcellulose fiber at a predetermined concentration is prepared.

Then, an aqueous resin mixture solution is prepared by adding an emulsion of an aqueous resin (e.g., a polyurethane resin) of a single film having an elongation at break of about 50% or greater to the suspension aqueous solution of microcellulose fibers.

In this regard, as described above, surfaces of the cellulose fibers are covered with the aqueous resin, and thus contact points where hydrogen bonds on the surfaces of the cellulose fibers are formed may be modified, which may suppress formation of hydrogen bonds between the fibers caused by hydroxyl groups on the surfaces of the cellulose fibers. Therefore, firm bonding formed by numerous hydrogen bonds on the surfaces of the microcellulose fibers may be suppressed, and thus mechanical strength (an elongation at break) of the separator may improve.

Further, as described above, the emulsion of the aqueous resin may be mixed so that an amount of the aqueous resin may be in a range of about 0.1 weight % to about 50 weight %, about 0.5 weight % to about 40 weight %, about 1 weight % to about 30 weight %, about 2 weight % to about 20 weight %, or about 5 weight % to about 15 weight % based on the total amount of the microcellulose fibers.

Also, a concentration of the microcellulose fibers in the solution may be appropriately controlled by using a method of forming a film. A solvent of the solution is preferably water in terms of easiness of handling and a cost, or another solvent having a vapor pressure higher than that of water may be added to water and used as the solvent.

<Coating Solution Preparation Process>

Next, a coating solution may be prepared by adding a water-soluble pore-forming agent to the aqueous resin mixture solution described above. The water-soluble pore-forming agent may be a conventional one. Examples of the water-soluble pore-forming agent may include higher alcohols such as 1,5-pentanediol and 1-methylamino-2,3-propanediol; lactones such as ε-caprolactone and α-acetyl-γ-butyllactone; glycols such as diethylene glycol, 1,3-butylene glycol, and propylene glycol; glycol ethers such as

triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methylethyl ether, and diethylene glycol diethyl ether; glycerin; propylene carbonate; and N-methylpyrrolidone. Among these, triethylene glycol butyl methyl ether may be used.

Also, an amount of the water-soluble pore-forming agent in the solution may be controlled according to characteristics of the film, but, in terms of securing necessary pores in the separator, the amount of the water-soluble pore-forming agent may be about 5 parts by weight or more or about 100 parts by weight or more based on 100 parts by weight of the microcellulose fibers, and the amount of the water-soluble pore-forming agent may be about 3000 parts by weight or less or about 1000 parts by weight or less based on 100 parts by weight of the microcellulose fibers. For example, the amount of the water-soluble pore-forming agent may be in a range of about 5 parts to about 3000 parts by weight, about 10 parts to about 2500 parts by weight, about 50 parts to about 2000 parts by weight, about 100 parts to about 1500 parts by weight, about 150 parts to about 1000 parts by weight, or about 200 parts to about 500 parts by weight based on 100 parts by weight of the microcellulose fibers.

<Coating Process>

Subsequently, the coating solution thus prepared is applied on to a substrate.

For example, the coating solution may be applied on to the substrate by combining several or at least two coating methods selected from methods using a comma coater, a roll coater, a reverse roll coater, a direct gravure coater, a reverse gravure coater, an offset gravure coater, a roll kiss coater, a reverse kiss coater, a micro gravure coater, an air doctor coater, a knife coater, a bar coater, a wire bar coater, a die coater, a dip coater, a blade coater, a brush coater, a curtain coater, a die-slot coater, and a cast coater. Also, the coating methods may be a batch type or a continuous type.

Also, examples of materials forming a substrate may include, but not limited to, polyesters (polyethylene terephthalate, polyethylene naphthalate, and polylactic acid), polyolefins (polyethylene and polypropylene), celluloses (cellulose and triacetyl cellulose), polyamides (nylon), acryls (polyacrylonitril), polystyrenes, polyimides, polycarbonates, polyvinlychlorides, polyurethanes, polyvinyl alcohols, paper, fluorides (Teflon®), glass, metal, and derivatives thereof.

Further, a shape of the substrate may be a film or a sheet but not limited thereto, and a thickness of the substrate may be in a range of about 10 um to about 1000 um or about 50 um to about 500 um.

Also, in consideration of adhesiveness of the film after applying and drying the coating solution on the substrate, surface treatments such as fluoride coating, corona treatment, plasma treatment, UV treatment, or anchor coating may be performed on the substrate.

<Drying Process>

Subsequently, non-woven fabric (a porous film) may be formed by drying the coating solution applied on the substrate. For example, the drying may be performed by hot-air dry, infrared ray dry, hot plate dry, or vacuum dry.

Also, in terms of sufficiently decreasing a residual amount of the solvent and the water-soluble pore-forming agent, the drying process may be performed at a temperature of about 50° C. or higher or about 60° C. or higher. Also, in terms of preventing deterioration of microcellulose fibers, the drying process may be performed at a temperature of about 200° C. or lower, about 150° C. or lower, or about 120° C. or lower. For example, the drying process may be performed at a temperature in a range of about 50° C. to about 200° C., about 55° C. to about 180° C., about 60° C. to about 160° C., about 65° C. to about 140° C., about 70° C. to about 120° C., or about 75° C. to about 100° C.

Further, a porous film may be formed after evaporating water and the water-soluble pore-forming agent, and then the porous film thus formed may be washed by using an organic solvent. Although the organic solvent is not particularly limited, but examples of the organic solvent may include toluene, acetone, methylethyl ketone, acetic acid ethyl, n-hexane, or propanol, which are organic solvents that have relatively fast volatile rates, and these may be used alone or as a combination of at least two selected therefrom or may be divided to be used from once to several times.

In order to wash the residual pore-forming agent, a solvent such as ethanol or methanol, which has a highly affinity with respect to water, may be used. However, moisture in a ceramic substrate may be moved to the solvent or moisture in the air may be absorbed by the film, and thus physical properties or a sheet shape of the cellulose porous film may be affected. Therefore, it is preferable to use the porous film in the state that its water content is managed. Solvents such as N-hexane and toluene, which have a high hydrophobic property, may have low washing effect on the hydrophilic pore-forming agent, but the solvents do not easily absorb water and thus may be appropriately used.

In this regard, the washing process may be repeated while changing the washing solvent in a manner that a hydrophobicity of the solvents gradually increases. For example, the washing may be performed by sequentially washing the porous film with different solvents of increasing hydrophobicity (e.g., acetone, toluene, and n-hexane, in order).

After the washing process, non-woven fabric may be separated from the substrate to obtain a porous film.

Then, the porous film thus obtained may be press-treated according to the need to manufacture a separator for a lithium ion secondary battery according to an embodiment.

Hereinafter, embodiments will be described in more detail with reference to Examples. However, these Examples are provided for illustrative purposes only, and the scope of the embodiments is not intended to be limited by these Examples.

(Preparation of Separator)

### Example 1

0.5 weight % of an emulsion of aqueous polyurethane (available from Dai-ichi Kogyo Seiyaku Co., LTD, Superflex 150HS, a non-reactive type having a polyether backbone, an elongation at break of a single film: 480%), as an aqueous resin, was added to 2.5 weight % or a water suspension of microcellulose fibers (a number average fiber diameter: 50 nm) to prepare a mixture, and then the mixture was stirred to prepare a first solution.

Then, pure water and triethylene glycol butyl methyl ether (available from Toho Chemicals), as a water-soluble pore-forming agent, were added to the first solution, and the resultant was stirred to prepare a coating solution.

Further, an amount of the final solid prepared by adding 10 parts by weight of aqueous polyurethane and 250 parts by weight of the water-soluble pore-forming agent based on 100 parts by weight of the microcellulose fibers was 0.5 weight %.

Subsequently, the coating solution was applied to a Schale, water in the solution was dried in an oven of 85° C., and then the resultant was sufficiently washed with toluene and separated from the Schale to obtain a porous film. Also, the porous film was pressed at 50 MPa to prepare a separator.

<Measurement of Thickness>

A thickness of the separator thus obtained was measured by using a micrometer (available from Teclock, PG-02J). The results of the measurement are shown in Table 1.

<Measurement of Permeability>

A permeability of the separator was measured. For example, a Gurley type densometer (available from Toyo Seiki Seisaku-Sho, Ltd.) was used, and a time for 100 ml of air to pass a test tube adhesively fixed on a circular hole having an outer circumference of 28.6 mm was measured. The results of the measurement are shown in Table 1.

<Measurement of Tensile Strength at a Break and Elongation at Break>

Based on JIS K-7127, a tensile strength at a break and an elongation at break of the separator were measured.

For example, a strip sample having a width of 15 mm and a length of 50 mm was prepared. Both end parts of the sample in a length direction were grasped in a tensile test device so that a distance between chucks was 10 mm, and then a tensile strength was measured under conditions of a temperature of 23° C. and a testing rate of 5 mm/min., so that a tensile strength at a point when the strip sample was broken was the tensile strength at break [kgf/cm²]. Also, a percent value obtained by dividing a displacement of the sample at break by 30 mm of the sample length except the chuck parts was an elongation at break [%]. The results are shown in Table 1.

<Measurement of Infrared Absorption Spectrum>

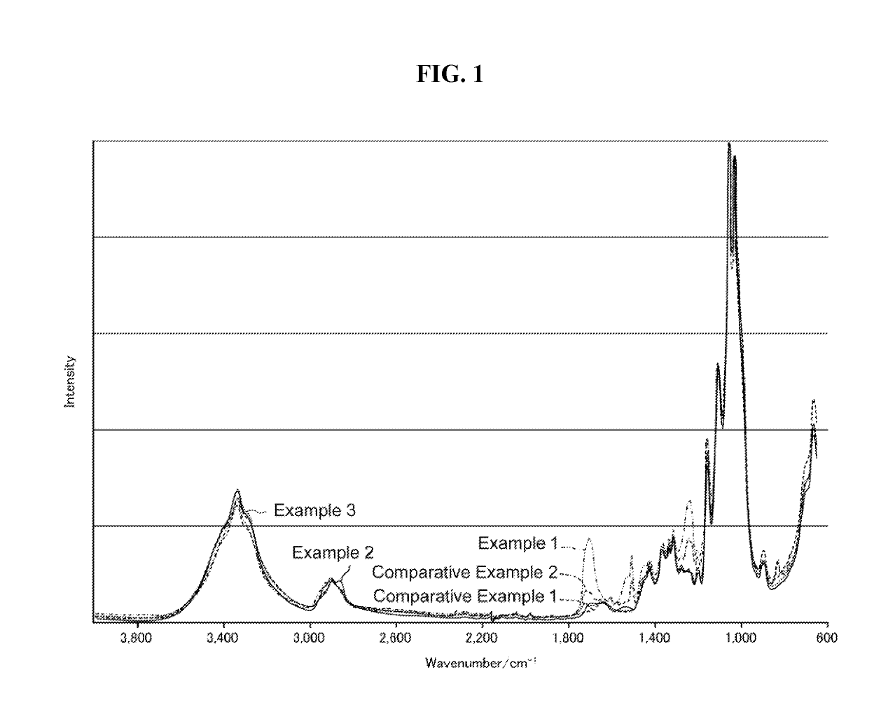

An attenuated total reflectance (ATR) spectrum of the separator was measured. In the measurement, Nicolet iS10 available from Thermo Scientific was used. A prism was diamond. An absorption intensity was further normalized by a peak near 1053 cm⁻¹. Also, whether a peak of a urethane bond (a peak near 1700 cm⁻¹) was observed or not in the spectrum was recorded. The result is shown in FIG. 1.

<Measurement of Capacity Retention Ratio>

A test cell was prepared by using a separator according to an embodiment. First, a cathode of the test cell was lithium cobalt acid (LiCoO₂), and an anode was artificial graphite. At 25° C., the test cell was charged/discharged (within a voltage of 4.35 V to 2.75 V) at a 10 hour rate to perform a formation process. Thereafter, the test cell was charged second time up to a voltage of 4.35 V at a 5 hour rate, and discharged until a voltage of 2.75 V to check an initial capacity. In addition, the test cell was charged third time until a voltage was 4.35 V at a 5 hour rate, and then the cell in its charged state was put into an incubator set at 60° C. After 24 hours, the cell was removed from the incubator, cooled to 25° C., and discharged until a voltage of 2.75 V at a 5 hour rate to measure a capacity. Also, a ratio of the obtained value to the initial capacity was a capacity retention ratio [%]. The results are shown in Table 1.

### Example 2

A separator was prepared in the same manner as used in Example 1, except that 0.5 weight % of an emulsion of an aqueous polyurethane (available from Dai-ichi Kogyo Seiyaku Co., LTD, Superflex E-4800, a non-reactive type having a polyether backbone and a polyester backbone, an elongation at break of a single film: 720%) was used as an aqueous resin. A thickness, a permeability, a tensile strength at break, and an elongation at break of the separator were measured. The results of the measurement are shown in Table 1.

### Example 3

A separator was prepared in the same manner as used in Example 1, except that 0.5 weight % of an emulsion of an aqueous polyurethane (available from Dai-ichi Kogyo Seiyaku Co., LTD, Elastron E-37, a reactive type having a polyester backbone, an elongation at break of a single film: 500%) was used as an aqueous resin, the coating solution was applied to a Schale to dry water in an oven at 85° C., and heat-treating the resultant at 150° C. for 1 hour. A thickness, a permeability, a tensile strength at break, and an elongation at break of the separator were measured. The results of the measurement are shown in Table 1.

### Example 4

A separator was prepared in the same manner as used in Example 1, except that 10 weight % of polyvinyl alcohol (available from Wako Pure Chemical Industries, a degree of polymerization: 3500, a saponification degree: 86 mol %, and an elongation at break of a single film: 240%) as an aqueous resin instead of aqueous polyurethane. A thickness, a permeability, a tensile strength at break, and an elongation at break of the separator were measured. The results of the measurement are shown in Table 2.

### Example 5

A separator was prepared in the same manner as used in Example 1, except that 10 weight % of an emulsion of maleic acid modified polyethylene (available from Dongyang fiber spinning, HARDLEN AP-03, an elongation at break of a single film: 400%) as an aqueous resin instead of aqueous polyurethane. A thickness, a permeability, a tensile strength at break, and an elongation at break of the separator were measured. The results of the measurement are shown in Table 2. Further, elongations at break in the second row of Table 2 are an elongation at break of a single film, and elongations at break in the second row from the bottom of Table 2 are elongations at break of the separators.

### Comparative Example 1

A separator was prepared in the same manner as used in Example 1, except that aqueous polyurethane was not used. A thickness, a permeability, a tensile strength at break, and an elongation at break of the separator were measured. The results of the measurement are shown in Table 1.

### Comparative Example 2

A separator was prepared in the same manner as used in Example 1, except that 0.5 weight % of an emulsion of an aqueous polyurethane (available from Dai-ichi Kogyo Seiyaku Co., LTD, Elastron H3-DF, a non-reactive type having a polyester backbone, an elongation at break of a single film: 40%) was used as an aqueous resin. A thickness, a permeability, a tensile strength at break, and an elongation at break of the separator were measured. The results of the measurement are shown in Table 1.

TABLE 1

| | | | | | Comparative | Comparative |
|---|---|---|---|---|---|---|
| | | Example 1 | Example 2 | Example 3 | Example 1 | Example 1 |
| Aqueous | Backbone | Polyether/ | Polyether | Polyester | — | Polyester |
| polyurethane | | polyester | | | | |
| | Type | Non- | Non- | Reactive | — | Reactive |
| | | reactive | reactive | | | |
| | Elongation at break [%] | 480 | 720 | 500 | — | 40 |
| | Amount based on the | 10 | 10 | 10 | — | 10 |
| | total amount of | | | | | |
| | cellulose [weight %] | | | | | |

| | | | | | |
|---|---|---|---|---|---|
| Thickness [um] | 15 | 16 | 14 | 16 | 16 |
| Gurley permeability [s/100 mL] | 382.7 | 548.8 | 280.8 | 291.7 | 263.9 |
| Tensile strength at break [kgf/cm²] | 445 | 489.2 | 389 | 353.7 | 263.9 |
| Elongation at break [%] | 4.57 | 7.64 | 4.73 | 2.95 | 2.60 |
| Capacity retention rate [%] | 72 | — | — | 71 | — |
| A peak near 1700 cm⁻¹ | Yes | Yes | Yes | No | Yes |

TABLE 2

| | Example 4 | Example 5 |
|---|---|---|
| | Polyvinyl | Maleic acid modified |
| Aqueous resin | alcohol | polyethylene emulsion |
| Elongation at break [%] | 240 | 400 |
| Amount based on the total | 10 | 10 |
| amount of cellulose [weight %] | | |
| Thickness [um] | 14.4 | 12.2 |
| Gurley permeability [s/100 mL] | 377.2 | 382.8 |
| Tensile strength at break [kgf/cm²] | 340.2 | 434.3 |
| Elongation at break [%] | 7.28 | 7.35 |
| Capacity retention rate [%] | — | — |

As shown in Table 1, Examples 1 to 3 using aqueous polyurethane of a single film having an elongation at break of at least 50% had an elongation at break of 3% or greater, indicating that the mechanical strength is excellent compared to that of Comparative Example 1 not using aqueous polyurethane and Comparative Example 2 using aqueous polyurethane of a single film having an elongation at break of less than 50%.

Also, as shown in Table 2, Example 4 using polyvinyl alcohol of a single film having an elongation at break of at least 50% and Example 5 using maleic acid modified polyethylene both had the elongations at break of greater than 3% as well as those of Examples 1 to 3, and thus Examples 4 and 5 also had excellent mechanical strength.

Further, it was confirmed that a lithium ion secondary battery including the separator prepared in Example 1 had a high capacity retention rate and excellent battery characteristics compared to those of the separator prepared in Comparative Example 1.

Also, in the ATR spectrum shown in FIG. 1, the separators of Examples 1 to 3 including aqueous polyurethane had a peak derived from a urethane bond (a peak near 1700 cm⁻¹), and thus existence of aqueous polyurethane in the separators may be confirmed.

As described above, according to one or more embodiments, non-woven fabric may have excellent mechanical strength and improved handleability.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A porous film comprising:
an aqueous resin, wherein a resin cast as a film has an elongation at break of about 50% or greater; and
cellulose nanofibers,
wherein an elongation at break of the porous film is about 3% or greater.

2. The porous film of claim 1, wherein the aqueous resin comprises at least one selected from a urethane resin, an acrylic resin, a phenol resin, a polyester resin, an epoxy resin, a polystyrene resin, a polyvinyl alcohol, a maleic acid modified polyethylene, and a polyacrylamide resin.

3. The porous film of claim 1, wherein the porous film comprises about 1 part to about 50 parts by weight of the aqueous resin per 100 parts by weight of the cellulose nanofibers.

4. The porous film of claim 1, wherein the cellulose nanofibers have an I-type crystalline structure.

5. The porous film of claim 1, wherein the cellulose nanofibers comprise at least one selected from plant cellulose, animal cellulose, and microbial cellulose.

6. The porous film of claim 1, wherein about 80 weight % or more of the cellulose nanofibers having a fiber diameter of less than about 1 um.

7. The porous film of claim 1, wherein the cellulose nanofibers have an average fiber diameter of about 3 nm to about 300 nm.

8. The porous film of claim 1, wherein a Gurley value is in a range of about 10 sec/100 cc to about 1000 sec/100 cc.

9. The porous film of claim 1, wherein a tensile strength at break of the porous film is about 200 kgf/cm² or greater.

10. A separator comprising the porous film of any one of claims 1 to 9.

11. The separator of claim 10, wherein a thickness of the separator is in a range of about 5 um to about 30 um.

12. An electrochemical device comprising the separator of claim 10.

13. The electrochemical device of claim 12, wherein the electrochemical device is a lithium battery or an electric double layer capacitor.

14. A method of preparing a porous film of claim 1, the method comprising:
combining cellulose nanofibers with an aqueous resin to prepare a resin mixture solution, wherein the aqueous resin when cast as a film has an elongation at break of about 50% or greater; and
combining a water-soluble pore-forming agent with the resin mixture solution; and
forming a porous film from the resin mixture solution.

15. The method of claim 14, wherein about 5 parts to about 3000 parts by weight of the water-soluble pore-forming agent is used per 100 parts by weight of the cellulose nanofibers.

16. The method of claim 14, wherein the water-soluble pore-forming agent comprises at least one selected from 1,5-pentanediol, 1-methylamino-2,3-propanediol, ε-caprolactone, α-acetyl-γ-butyrolactone, diethylene glycol, 1,3-butylene glycol, propylene glycol, triethylene glycol dimethyl ether, tripropylene glycol dimethyl ether, diethylene glycol monobutyl ether, triethylene glycol monomethyl ether, triethylene glycol butyl methyl ether, tetraethylene glycol dimethyl ether, diethylene glycol monoethyl ether acetate, diethylene glycol monoethyl ether, triethylene glycol monobutyl ether, tetraethylene glycol monobutyl ether, dipropylene glycol monomethyl ether, diethylene glycol monomethyl ether, diethylene glycol monoisopropyl ether, ethylene glycol monoisobutyl ether, tripropylene glycol monomethyl ether, diethylene glycol methyl ethyl ether, diethylene glycol diethyl ether, glycerin, propylene carbonate, and N-methylpyrrolidone.

17. The method of claim 14 further comprising washing the porous film with an organic solvent.

18. The method of claim 17, wherein washing of the porous film with an organic solvent comprises sequentially washing the porous film with different solvents of increasing hydrophobicity.
